(19) United States
(12) Patent Application Publication
(10) Pub. No.: US 2025/0319705 A1
(43) Pub. Date: Oct. 16, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: HIROYUKI SHIOIRI, Kanagawa (JP)

(21) Appl. No.: 19/173,257

(22) Filed: Apr. 8, 2025

(30) Foreign Application Priority Data
Apr. 15, 2024 (JP) 2024-065811

(51) Int. Cl. B41J 11/00; G06F 3/12

(52) U.S. Cl. CPC B41J 11/002; G06F 3/1205; G06F 3/1251; G06F 3/1254; G06F 3/1286

(57) ABSTRACT

An information processing apparatus includes one or more memories storing instructions, and one or more processors that, upon execution of the stored instructions, configure the one or more processors to operate as a control unit that forms a three-dimensional image on a recording medium based on first three-dimensional image data included in input image data, and a generation unit that generates second three-dimensional image data based on the input image data in a case where the input image data does not include three-dimensional image data.

### BACKGROUND

### Field

The present disclosure relates to techniques for forming three-dimensional (3D) images.

### Description of the Related Art

Typically known image forming systems form images on recording media using color inks for image formation, such as cyan ink, magenta ink, yellow ink, and black ink, as well as white ink for base layer formation. For example, Japanese Patent Application Laid-Open No. 2020-107198 discusses a technique in which a special color image layer in white or clear is generated based on user input, and the generated special color image layer is included in a print job.

In Japanese Patent Application Laid-Open No. 2020-107198, a special color image layer in white, clear, or metallic is generated, but forming a 3D image on a recording medium is not considered.

### SUMMARY

The present disclosure is directed to forming a three-dimensional (3D) image on a recording medium.

To address the foregoing issues, according to an aspect of the present disclosure, an information processing apparatus includes one or more memories storing instructions, and one or more processors that, upon execution of the stored instructions, configure the one or more processors to operate as a control unit that forms a three-dimensional image on a recording medium based on first three-dimensional image data included in input image data, and a generation unit that generates second three-dimensional image data based on the input image data in a case where the input image data does not include three-dimensional image data.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of an image forming system.

FIG. 2 is a block diagram illustrating an example of a functional configuration of an image forming apparatus.

FIG. 3 is a diagram illustrating a cross section of a recording medium including a foaming layer.

FIG. 4 is a diagram illustrating a process of generating three-dimensional (3D) image data based on color image data.

FIG. 5 is a diagram illustrating a process of generating 3D image data based on white image data.

FIG. 6 is a flowchart illustrating a process of generating 3D image data.

FIGS. 7A and 7B are diagrams illustrating examples of user interfaces.

FIG. 8 is a diagram illustrating a process of generating 3D image data based on color image data.

FIG. 9 is a flowchart illustrating a process of generating 3D image data.

### DESCRIPTION OF THE EMBODIMENTS

Hereinafter, exemplary embodiments will be described with reference to the accompanying drawings. The following embodiments do not necessarily limit the present disclosure. Furthermore, not all combinations of features described in each exemplary embodiment are essential to the solutions of the present disclosure.

A first exemplary embodiment of the present disclosure will be described. In the present exemplary embodiment, three-dimensional (3D) image printing is performed using foam promoting ink and a recording medium that includes a foaming layer. The foam promoting ink is ejected from a print head onto the recording medium, and penetrates into the foaming layer of the recording medium. When the foam promoting ink has penetrated the foaming layer and the foaming layer is heated, the foaming material contained in the foaming layer expands and forms a raised portion. In the present exemplary embodiment, the foam promoting ink is colorless and does not affect the color of a color image even when used together with color inks, but the foam promoting ink may be colored.

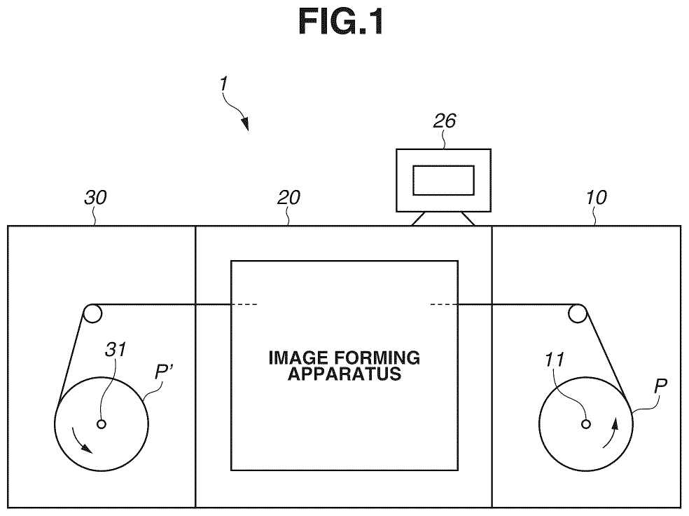

FIG. 1 is a diagram illustrating a configuration example of an image forming system 1 in the present exemplary embodiment. The image forming system 1 forms an image on a roll sheet (continuous sheet) P serving as a recording medium that allows continuous image formation. The image forming system 1 includes a sheet feeding device 10, an image forming apparatus 20, and a winding unit 30, all connected in the conveyance direction of the roll sheet P from upstream. The sheet feeding device 10 supplies the roll sheet P to the image forming apparatus 20. The sheet feeding device 10 rotates a paper tube of the roll sheet P about a rotation shaft 11, thus conveying the roll sheet P wound on the paper tube toward the image forming apparatus 20 at a constant speed via a plurality of rollers, such as a conveyance roller and a sheet feeding roller. The image forming apparatus 20 controls the formation of an image on the roll sheet P supplied from the sheet feeding device 10. The image forming apparatus 20 conveys the roll sheet P with the image formed thereon toward the winding unit 30. The winding unit 30 winds the roll sheet P conveyed from the image forming apparatus 20 into a roll onto a paper tube. The roll sheet P is, for example, wound on a paper tube set to a rotation shaft 31 and held in a roll, as illustrated in FIG. 1. The winding unit 30 rotates the roll sheet P that has been conveyed to the paper tube, about the rotation shaft 31, thus winding the roll sheet P as a roll sheet product P′ onto the paper tube set to the rotation shaft 31 at a constant speed via a plurality of rollers, such as a conveyance roller and a sheet discharge roller.

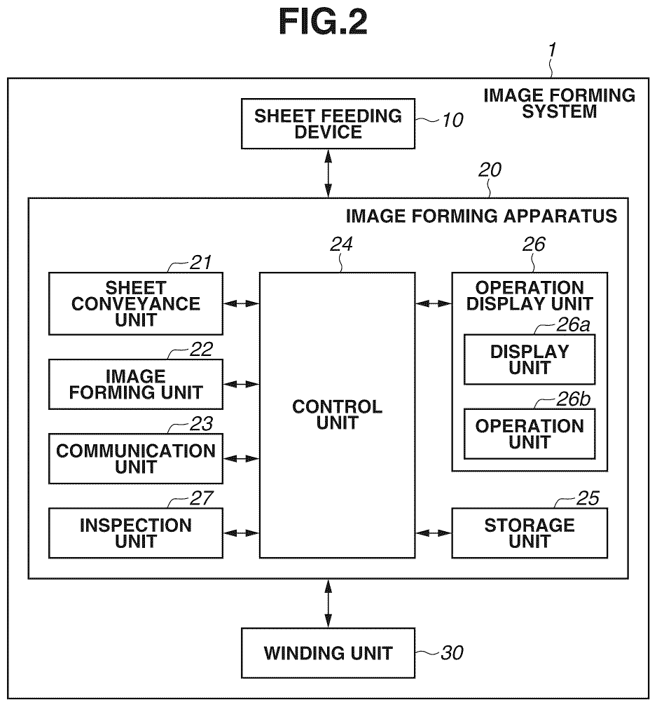

FIG. 2 is a block diagram illustrating an example of a functional configuration of the image forming apparatus 20. The image forming apparatus 20 includes a sheet conveyance unit 21, an image forming unit 22, a communication unit 23, a control unit 24, a storage unit 25, an operation display unit 26, and an inspection unit 27. The sheet conveyance unit 21 serves as a conveyance mechanism for the roll sheet P in the image forming apparatus 20. The sheet conveyance unit 21 conveys the roll sheet P conveyed from the sheet feeding device 10 to the image forming unit 22 with a plurality of rollers, and conveys the roll sheet P having passed through the image forming unit 22 to the winding unit 30. The image forming unit 22 forms an image on the roll sheet P supplied from the sheet feeding device 10 based on the print data corresponding to an output instruction from the user. The image forming unit 22 includes print heads each corresponding to a different one of four color inks of cyan (C), magenta (M), yellow (Y), and black (K), as well as print heads for white ink for base layer formation and the foam promoting ink. The image forming unit 22 conveys the roll sheet P with an image formed thereon toward the winding unit 30. The communication unit 23 includes a communication control card, such as a local area network (LAN) card. The communication unit 23 transmits and receives various types of data to and from an external device (e.g., a personal computer) connected to a communication network, such as a local area network (LAN) or a wide area network (WAN). The control unit 24 includes a central processing unit (CPU) and a random access memory (RAM). The CPU of the control unit 24 reads various programs, such as a system program and a processing program, stored in the storage unit 25, loads the programs into the RAM, and executes various processes in accordance with the loaded programs. The control unit 24 can perform image forming processing for executing an image forming job (hereinafter referred to as a job) in response to an instruction from the user. The storage unit 25 includes a nonvolatile semiconductor memory (flash memory) and a hard disk drive (HDD). The storage unit 25 stores various programs, such as a system program and a processing program, executed by the control unit 24, as well as various types of data to be used for executing these programs. The image forming apparatus 20 in the present exemplary embodiment functions as an information processing apparatus including the control unit 24, but a separate information processing apparatus connected to the image forming apparatus 20 may function as the control unit 24.

The operation display unit 26 includes a liquid crystal display (LCD) with a touch panel, and is provided with a display unit 26a and an operation unit 26b. The display unit 26a displays various types of information on a display screen in accordance with display control signals input from the control unit 24. The operation unit 26b includes various operation keys, such as a numeric keypad and a start key, receives various input operations from the user, and outputs operation signals to the control unit 24. The operation display unit 26 is used, for example, for setting divider information in execution of a job. The divider information indicates the insertion positions of divider pages that are preinserted into a job in a case where the roll sheet product P′ after image forming processing is to be divided into a plurality of rolls for delivery. The divider information is generated under user setting conditions, such as the number of printed pages, the number of copies, a printing length, a printing weight, and a printing diameter, as desired.

Operation of the image forming apparatus 20 that performs image forming processing on the roll sheet P will now be described. Initially, the user creates data for a job on an external apparatus, sets a print setting and a delivery volume setting for the job, and transmits these pieces of information (data) to the image forming apparatus 20 via the communication network. The control unit 24 of the image forming apparatus 20 receives, via the communication unit 23, the job data transmitted from the external apparatus and a job ticket including the information about the job print setting and delivery volume setting. The inspection unit 27 checks whether printing has been performed without ink ejection failures. A pattern for ink ejection failure inspection is printed and the printed pattern is scanned to check for any areas with ink ejection failures in the printed image. If an ink ejection failure is detected, countermeasures, such as performing nozzle maintenance and stopping the image forming apparatus 20, are performed.

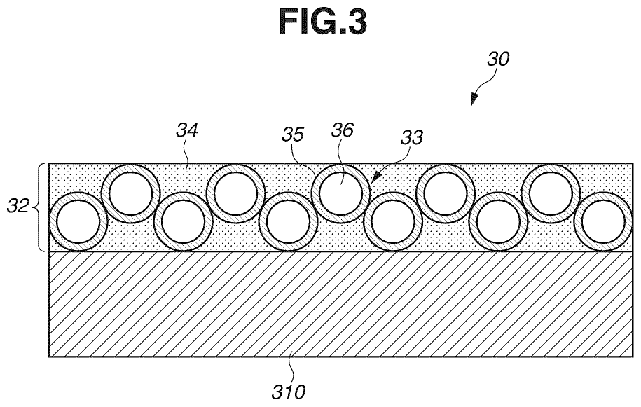

FIG. 3 is a diagram schematically illustrating an example of a cross section of a recording medium that has a foaming layer used in the present exemplary embodiment. An example of forming a raised portion on the surface of the recording medium will be described. A foaming layer-integrated recording medium 300 (hereinafter, also referred to as recording medium 300) includes a substrate 310 and a foaming layer 32 on the substrate 310. The foaming layer 32 contains foaming particles 33 that foam when heated.

The substrate 310 functions as a support for supporting the foaming layer 32. The type of the substrate 310 is not particularly limited. For example, the substrate 310 can be paper made from natural pulp, kenaf paper, or plastic film sheets, such as polypropylene, polyethylene, and polyester. Additionally, the substrate 310 can be synthetic paper or nonwoven fabrics, made by paperizing synthetic fibers, synthetic pulp, or synthetic resin films.

The foaming layer 32 contains the foaming particles 33 and binder resin 34, and is disposed on at least one of the front and back surfaces of the substrate 310. The foaming particles 33 are thermally expandable microcapsules each of which has a capsule-like shell layer 35 containing thermoplastic resin and a volatile material 36 sealed inside the shell layer 35. When heat is applied to the foaming particles 33, the thermoplastic resin included in each shell layer 35 softens, and the volatile material 36 sealed inside the shell layer 35 vaporizes, resulting in an expansion of the volume. Thus, the foaming particles 33 expand like balloons.

Examples of the thermoplastic resin contained in the shell layers 35 include polystyrene, styrene-acrylic ester copolymer, polyamide resin, polyacrylic ester, polyvinylidene chloride, polyacrylonitrile, and polymethyl methacrylate. Other examples include vinylidene chloride-acrylonitrile copolymer, methacrylic ester-acrylic acid copolymer, vinylidene chloride-acrylic acid copolymer, and vinylidene chloride-acrylic ester copolymer.

Examples of the volatile material 36 include low molecular weight hydrocarbons, such as ethane, ethylene, propane, propene, n-butane, isobutane, n-pentane, isopentane, neopentane, n-hexane, heptane, and petroleum ether. Additionally, there are chlorofluorocarbons, such as CCl₃F, CCl₂F₂, CClF₃, and CClF₂—CClF₂, as well as tetraalkylsilanes, such as tetramethylsilane, trimethylethylsilane, trimethylisopropylsilane, and trimethyl-n-propylsilane. It is desirable that the volatile material 36 include hydrocarbons with a molecular weight of 120 or less. There is no particular restriction on the lower limit of the molecular weight of the volatile material 36, but it is desirably 50 or more. The foaming particles 33 content in the foaming layer 32 is desirably 5 mass % or more and 95 mass % or less based on the total mass of the foaming layer 32.

The foaming layer 32 contains the binder resin 34 to enhance adhesion to the substrate 310.

The binder resin 34 plays an important role in preventing the foaming layer 32 from peeling off from the substrate 310 when the foaming particles 33 in the foaming layer 32 expand due to heat. Water-insoluble resin is included in the binder resin 34, so that the binder resin 34 is less likely to dissolve even in the water in the foam promoting ink. This prevents a decrease in adhesion between the foaming layer 32 and the substrate 310 caused by the foam promoting ink. Even if water-based ink, which contains water, is applied to a recording medium, a decrease in the adhesion between the foaming layer 32 and the substrate 310 can be prevented for a similar reason. The water-insoluble resin in the present exemplary embodiment is defined as a resin that retains 95 mass % or more of its weight after being immersed in 80° C. hot water for two hours. The water-insoluble resin is desirably at least one type of resin selected from the group consisting of acrylic resins and urethane resins. Furthermore, the water-insoluble resin is more desirably at least one type of resin selected from the group consisting of acrylic resins that do not contain ester groups and urethane resins that do not contain ester groups. The water-insoluble resin is desirably non-hygroscopic resin. The water-insoluble resin content of the foaming layer 32 is desirably 10 mass % or more and 95 mass % or less, based on the total mass of the foaming layer 32. The foaming layer 32 may also contain water-soluble resin in addition to the water-insoluble resin, within a range in which an effect of preventing the foaming layer 32 from peeling off from the substrate 310 is obtainable when the foaming particles 33 in the foaming layer 32 expand due to heat. The glass transition temperature of the binder resin 34 is desirably between −10° C. and 30° C. inclusive. Setting the glass transition temperature of the binder resin 34 within this range prevents the binder resin 34 from hindering the expansion of the foaming particles 33.

The mass ratio of the foaming particles 33 to the binder resin 34 is desirably in the range of 5:95 to 90:10 (the foaming particles 33: the binder resin 34). Setting the mass ratio of the foaming particles 33 to the binder resin 34 within this range enhances both the foamability of the foaming particles 33 and the adhesion of the binder resin 34 to the substrate 310. The foaming layer 32 may further contain components such as pigments, antioxidants, dyes, and surfactants, within a range that does not impair the foamability.

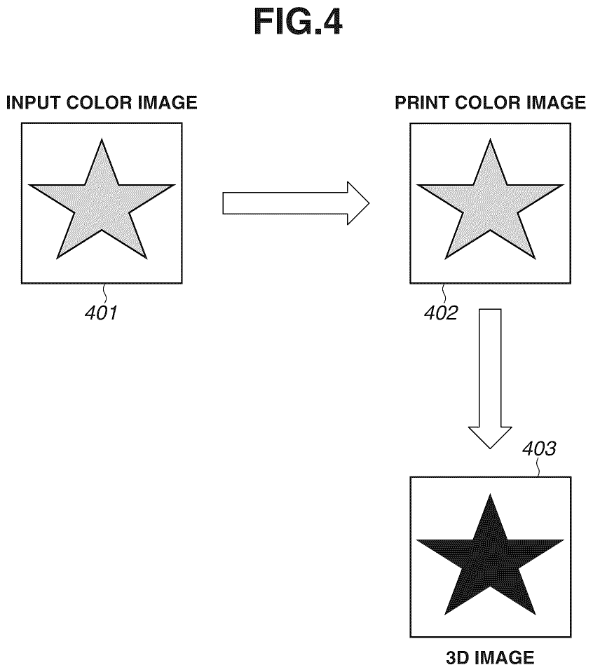

FIG. 4 is a diagram illustrating a process of generating 3D image data based on color image data. The data on an input color image 401 is vector data input via the communication unit 23. The data format of the input color image 401 is, for example, Portable Document Format (PDF). The input color image 401 includes color in the star-shaped area. The data on the input color image 401 is subjected to raster image processor (RIP) processing, resulting in generation of raster data for a print color image 402. The data format of the print color image 402 is, for example, Tagged Image File Format (TIFF) or raw image format (RAW). The data on a 3D image 403 is raster data generated based on the data on the print color image 402, and serves as data that specifies the foaming area(s) on the foaming layer-integrated recording medium 300 using pixel values. In the 3D image 403, foam promoting ink is ejected to the star-shaped area. In generating the data for the 3D image 403, the pixel values (CMYK values) of the print color image 402 are used to calculate the pixel values of the 3D image 403. To calculate the pixel values of the 3D image 403, for example, a known technique is used that converts a two-dimensional (2D) image into a 3D image in such a manner that the height information corresponding to the area(s) with high luminance values (low density) is increased. Alternatively, the pixel values of the 3D image 403 may be calculated so that a predetermined amount of foam promoting ink is ejected in the area(s) where the pixel values on the print color image 402 are not zero and color ink is to be discharged. The amount of the foam promoting ink to be ejected may be a prefixed amount or an amount specified by the user via the operation unit 26b. The user can also specify the height of the raised portion(s) in a 3D image via the operation unit 26b. The input color image 401 may be raster data, in which case the pixel values of the 3D image 403 can be calculated based on the pixel values of the input color image 401 without performing RIP processing.

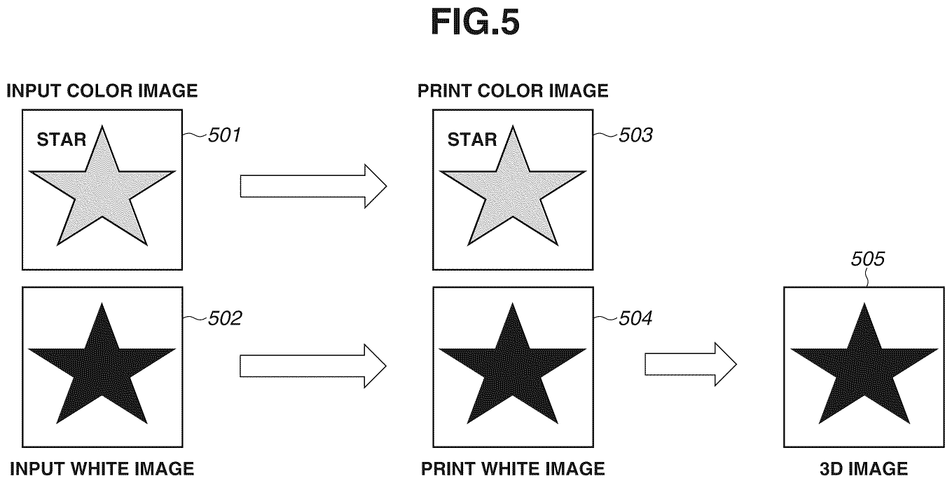

FIG. 5 is a diagram illustrating a process of generating 3D image data based on white image data. The data on an input color image 501 and an input white image 502 is vector data input through the communication unit 23. The data format of the input color image 501 and the input white image 502 is, for example, PDF format. The input color image 501 and the input white image 502 may be included in one PDF file or may be separated into different PDF files. The data on the input color image 501 is subjected to RIP processing, resulting in generation of raster data for a print color image 503. The data on the input white image 502 is subjected to RIP processing, resulting in generation of raster data for a print white image 504. The data format of the print color image 503 and the print white image 504 is, for example, TIFF format or RAW format. The data on a 3D image 505 is raster data generated based on the data on the print white image 504, and specifies the foaming area(s) on the foaming layer-integrated recording medium 300 using pixel values. For the pixel values of the 3D image 505, for example, the pixel values of the print white image 504 can be copied and used.

The input color image 501 in the example of FIG. 5 includes thin “star” characters, but the input white image 502 does not include any thin characters. The absence of thin characters and lines in an input white image is intended to avoid the misalignment between a white ink background and a thin character and a line in color ink, which can occur when ink ejection precision is not high. Thus, data for the input white image 502 may be created such that the input white image 502 includes no thin characters or lines. Generating the data for the 3D image 505 based on the print white image 504 that includes no thin characters or lines ensures that the 3D image 505 does not include any thin characters or lines, either. This prevents the misalignment between the raised portion(s) created by foam promoting ink and thin character(s) and line(s) in color ink.

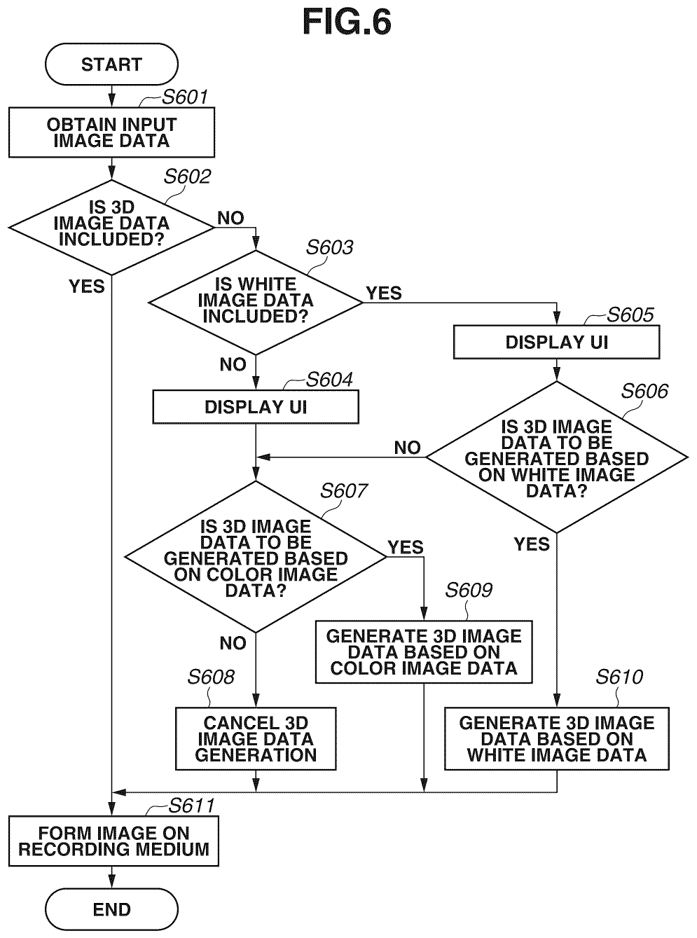

FIG. 6 is a flowchart illustrating a process for generating 3D image data. The process illustrated in the flowchart of FIG. 6 is started when the user inputs an instruction via the operation unit 26b and the CPU of the control unit 24 receives the input instruction. The user's instruction is issued by, for example, selecting a 3D image forming mode or a recording medium for 3D image formation. In step S601, the control unit 24 obtains input image data input through the communication unit 23. The input image data in the present exemplary embodiment may be color image data or both color image data and white image data. Alternatively, the data may include both color image data and 3D image data. In step S602, the control unit 24 determines whether the input image data includes 3D image data. If the control unit 24 determines that the input image data includes 3D image data (YES in step S602), the processing proceeds to step S611. If the control unit 24 determines that the input image data does not include 3D image data (NO in step S602), the processing proceeds to step S603.

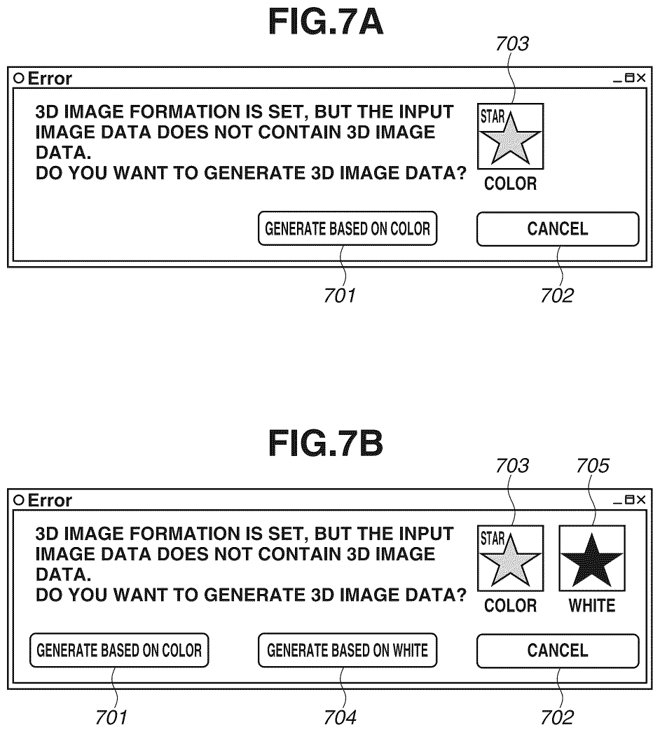

In step S603, the control unit 24 determines whether the input image data includes white image data. If the control unit 24 determines that the input image data includes white image data (YES in step S603), the processing proceeds to step S605. If the control unit 24 determines that the input image data includes no white image data (NO in step S603), the processing proceeds to step S604. In step S604, the control unit 24 displays, on the display unit 26a, a user interface (UI) for receiving an instruction as to whether to generate 3D image data based on the color image data. FIG. 7A illustrates an example of the UI. A button 701 is used for selecting generation of 3D image data based on color image data. A button 702 is used for selecting cancellation of 3D image formation. A display image 703 is a preview image corresponding to the color image data. In step S605, the control unit 24 displays, on the display unit 26a, a UI for receiving an instruction to select one of the following: generating 3D image data based on the color image data; generating 3D image data based on the white image data; and not generating 3D image data. FIG. 7B illustrates an example of the UI. A button 704 is used for selecting generation of 3D image data based on white image data. A display image 705 is a preview image corresponding to the white image data.

In step S606, the control unit 24 determines whether an instruction to generate 3D image data based on the white image data is received. If the control unit 24 determines that an instruction to generate 3D image data based on the white image data is received (YES in step S606), the processing proceeds to step S610. If the control unit 24 determines that no instruction to generate 3D image data based on the white image data is received (NO in step S606), the processing proceeds to step S607. In step S607, the control unit 24 determines whether an instruction to generate 3D image data based on the color image data is received. If the control unit 24 determines that an instruction to generate 3D image data based on the color image data is received (YES in step S607), the processing proceeds to step S609. If the control unit 24 determines that no instruction to generate 3D image data based on the color image data is received (NO in step S607), the processing proceeds to step S608.

In step S608, the control unit 24 determines that printing is performed using only the color image data, or both the color image data and the white image data, without generating 3D image data. In step S609, the control unit 24 generates 3D image data based on the color image data. In step S610, the control unit 24 generates 3D image data based on the white image data. The method for 3D image data generation is as described above. In step S611, the control unit 24 causes the image forming unit 22 to form an image on the recording medium. In a case where the input image data includes 3D image data or where 3D image data has been generated, a 3D image is formed on the recording medium in addition to a color image and/or a white image. If no 3D image data has been generated, no 3D image is formed, and a color image and/or white image is formed on the recording medium.

According to the processes of the present exemplary embodiment described above, even with the absence of 3D image data in input image data, 3D image data can be generated based on the color image data or white image data included in the input image data.

A second exemplary embodiment of the present disclosure will now be described. In generating 3D image data based on color image data, the thin character(s) and line(s) are removed, and then the 3D image data is generated. The configuration of the image forming system 1 in the present exemplary embodiment is similar to that of the first exemplary embodiment, and thus, the description thereof will be omitted. Hereinafter, differences between the present exemplary embodiment and the first exemplary embodiment will mainly be described. Components similar to those of the first exemplary embodiment are denoted by the same reference numerals.

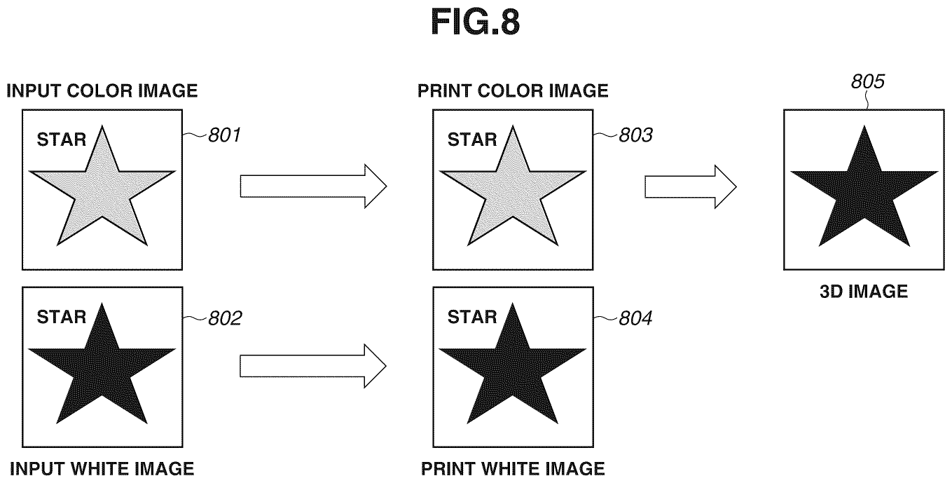

FIG. 8 is a diagram illustrating a process of generating 3D image data based on color image data. The data on an input color image 801 and an input white image 802 is vector data input through the communication unit 23. The data on the input color image 801 is subjected to RIP processing, resulting in generation of raster data for a print color image 803. The data on the input white image 802 is subjected to RIP processing, resulting in generation of raster data for a print white image 804. Data for a 3D image 805 is generated based on a color image with the thin character(s) and line(s) removed. The identification of thin characters and lines can be performed, for example, using known edge detection processing.

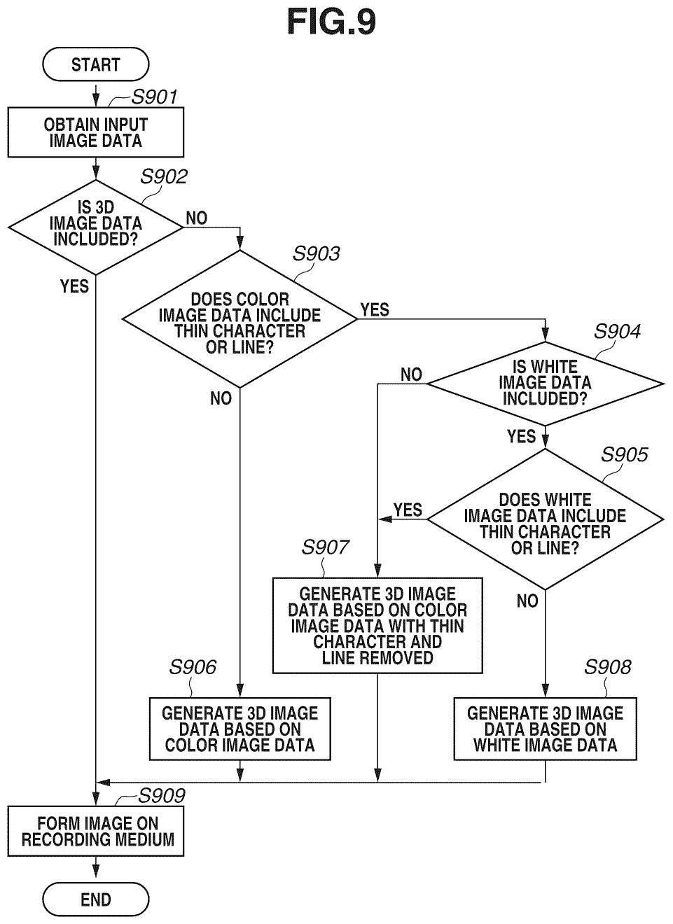

FIG. 9 is a flowchart illustrating a process for generating 3D image data. The process illustrated in the flowchart of FIG. 9 is started when the user inputs an instruction via the operation unit 26b and the CPU of the control unit 24 receives the input instruction. In step S901, the control unit 24 obtains input image data input through the communication unit 23. In step S902, the control unit 24 determines whether the input image data includes 3D image data. If the control unit 24 determines that the input image data includes 3D image data (YES in step S902), the processing proceeds to step S909. If the control unit 24 determines that the input image data does not include 3D image data (NO in step S902), the processing proceeds to step S903. In step S903, the control unit 24 determines whether the color image data includes a thin character or line. If the control unit 24 determines that the color image data includes a thin character or line (YES in step S903), the processing proceeds to step S904. If the control unit 24 determines that the color image data does not include a thin character or line (NO in step S903), the processing proceeds to step S906.

In step S904, the control unit 24 determines whether the input image data includes white image data. If the control unit 24 determines that the input image data includes white image data (YES in step S904), the processing proceeds to step S905. If the control unit 24 determines that the input image data does not include white image data (NO in step S904), the processing proceeds to step S907. In step S905, the control unit 24 determines whether the white image data includes a thin character or line. If the control unit 24 determines that the white image data includes a thin character or line (YES in step S905), the processing proceeds to step S907. If the control unit 24 determines that the white image does not include a thin character or line (NO in step S905), the processing proceeds to step S908.

In step S906, the control unit 24 generates 3D image data based on the color image data. In step S907, the control unit 24 removes the thin character(s) and line(s) from a color image, and generates 3D image data based on the color image data representing the color image with the thin character(s) and line(s) removed. In step S908, the control unit 24 generates 3D image data based on the white image data. In step S909, the control unit 24 causes the image forming unit 22 to form an image on a recording medium.

According to the processes in the present exemplary embodiment described above, even with the absence of 3D image data in input image data, 3D image data can be generated based on the color image data or white image data included in the input image data. Moreover, the misalignment between the raised portion(s) of a 3D image and a thin character and a line in color ink can be prevented.

### OTHER EMBODIMENTS

In the above-described exemplary embodiments, the user is prompted to select whether to generate 3D image data via the UI. Alternatively, the job information input through the communication unit 23 may include information indicating whether to generate 3D image data based on color image data or white image data.

The image forming apparatus 20 in the above-described exemplary embodiments is equipped with CMYK four-color inks as well as white ink and foam promoting ink, but the inks to be provided for are not limited to these examples. For example, the image forming apparatus 20 may be equipped with light-colored inks, such as light cyan and light magenta, special color inks, such as red and green, metallic inks, such as gold and silver, clear ink, fluorescent ink, and reaction liquids for fixing ink to a recording medium. If the input image data includes special color image data, metallic image data, clear image data, and/or other image data, 3D image data may be generated based on the pieces of image data.

The image forming apparatus 20 in the above-described exemplary embodiments includes line-type print heads configured to cover the entire recording width of the recording medium, but the print heads are not limited to the above example. For example, the image forming apparatus 20 may include serial-type print heads that perform image formation through reciprocating movement in directions perpendicular to the conveyance direction of the recording medium in combination with the operation of conveyance of the recording medium. Additionally, the recording medium is not limited to a roll sheet and may also be a cut sheet.

In the above-described exemplary embodiments, 3D image data is generated based on the entire color image or the entire white image, but 3D image data may be generated based on a partial area of a color image or a white image. The respective partial areas may be an area at a prefixed position or an area designated by the user via the operation unit 26b. Alternatively, 3D image data may be generated based on specific color information designated in color image.

In the above-described exemplary embodiments, a 3D image is formed using foam promoting ink and a recording medium with a foaming layer, but the method of forming a 3D image is not limited to the above examples. For example, a 3D image may be formed using curing ink, which hardens with light, such as ultraviolet rays or visible rays, or heat. The printing method may be an electrophotographic method instead of an inkjet method. The recording material used in printing may be toner instead of ink.

According to the present disclosure, a 3D image can be formed on a recording medium.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-065811, filed Apr. 15, 2024, which is hereby incorporated by reference herein in its entirety.

What is claimed is:

1. An information processing apparatus, comprising:
one or more memories storing instructions; and
one or more processors that, upon execution of the stored instructions, configure the one or more processors to operate as:
a control unit that forms a three-dimensional image on a recording medium based on first three-dimensional image data included in input image data; and
a generation unit that generates second three-dimensional image data based on the input image data in a case where the input image data does not include three-dimensional image data.

2. The information processing apparatus according to claim 1, wherein, in a case where the input image data does not include three-dimensional image data, the control unit forms a three-dimensional image on the recording medium based on the generated second three-dimensional image data.

3. The information processing apparatus according to claim 1, wherein execution of the stored instructions further causes the one or more processors to operate as a determination unit that determines whether the input image data includes three-dimensional image data, and, in a case where it is determined that the input image data does not include three-dimensional image data, causes the generation unit to generate the second three-dimensional image data based on the input image data.

4. The information processing apparatus according to claim 1, wherein the generation unit generates the second three-dimensional image data based on color image data included in the input image data.

5. The information processing apparatus according to claim 1, wherein the generation unit generates the second three-dimensional image data based on white image data included in the input image data.

6. The information processing apparatus according to claim 1, wherein the generation unit generates the second three-dimensional image data based on special color image data, metallic image data, or clear image data included in the input image data.

7. The information processing apparatus according to claim 1, wherein, in a case where a color image represented by color image data included in the input image data does not include a character or a line, the generation unit generates the second three-dimensional image data based on the color image data.

8. The information processing apparatus according to claim 7, wherein, in a case where the color image includes a character or a line or both a character and a line, the generation unit removes the character or the line or character and line from the color image and generates the second three-dimensional image data based on color image data representing the color image with the character or the line or character and line removed.

9. The information processing apparatus according to claim 7, wherein, in a case where the color image includes a character or a line, and a white image represented by white image data included in the input image data does not include a character or a line, the generation unit generates the second three-dimensional image data based on the white image data.

10. The information processing apparatus according to claim 1, wherein the control unit causes a forming unit to form the three-dimensional image, the forming unit being configured to form a three-dimensional image using foam promoting ink and a recording medium including a foaming material.

11. The information processing apparatus according to claim 1, wherein the control unit causes a forming unit to form the three-dimensional image, the forming unit being configured to form a three-dimensional image by curing ink with light or heat.

12. An information processing method, comprising:
forming a three-dimensional image on a recording medium based on first three-dimensional image data included in the input image data; and
generating second three-dimensional image data based on the input image data in a case where the input image data does not include three-dimensional image data.

13. A non-transitory computer-readable storage medium storing instructions that, when executed by a computer, cause the computer to perform an information processing method, the information processing method comprising:
forming a three-dimensional image on a recording medium based on first three-dimensional image data included in input image data; and
generating second three-dimensional image data based on the input image data in a case where the input image data does not include three-dimensional image data.
